(19) United States
(12) Patent Application Publication
(10) Pub. No.: US 2026/0091352 A1
(43) Pub. Date: Apr. 2, 2026

(54) MITIGATION OF GREENHOUSE GASES

(71) Applicant: JOHNSON MATTHEY PUBLIC LIMITED COMPANY, London (GB)

(72) Inventors: Joseph MCCARNEY, Sonning Common (GB); Andrew SCULLARD, Sonning Common (GB)

(21) Appl. No.: 19/110,689

(22) PCT Filed: Sep. 26, 2023
(86) PCT No.: PCT/GB2023/052484

§ 371 Date: Mar. 11, 2025

(30) Foreign Application Priority Data
Nov. 8, 2022 (EP) 22206211.9

(51) Int. Cl. B01D 53/72; B01D 53/76; H01M 8/04119; H01M 8/0612; H01M 8/0668; H01M 8/1007; H01M 8/12

(52) U.S. Cl. CPC B01D 53/72; B01D 53/76; H01M 8/04164; H01M 8/0618; H01M 8/0668; H01M 8/1007; B01D 2257/7025; B01D 2258/0266; H01M 2008/1293

(57) ABSTRACT

A method of reducing the greenhouse gas impact of livestock farming includes feeding a fuel gas comprising one or more hydrocarbons to an anode of a solid oxide fuel cell stack, withdrawing air, that includes methane originating from livestock, from a livestock housing or enclosure and feeding the withdrawn air to a cathode of the solid oxide fuel cell stack. The oxygen in the air is allowed exothermically to react with the one or more hydrocarbons in the fuel gas to form at the anode a heated first exhaust stream comprising water and carbon dioxide and at the cathode a heated second exhaust stream comprising methane, thereby generating an electrical current from the solid oxide fuel cell stack through an external electrical circuit. At least the heated second exhaust stream is fed to a combustor and combusted, producing a heated tail gas stream.

This invention relates to the mitigation of greenhouse gases. In particular, the invention relates to a method of reducing the greenhouse gas impact of livestock farming.

Cattle farming is a form of business aimed at raising cattle for various purposes, including dairy, beef and leather. It is estimated that the world has about 1.5 billion cattle. Cattle farming is one of the largest contributors to greenhouse gases and cattle are worldwide the largest agricultural source of greenhouse gases, particularly methane caused by enteric fermentation during digestion. Each year, a single cow will belch about 90 kg of methane. Although methane is shorter lived than carbon dioxide, it is about 28 times more potent in warming the atmosphere. Cattle farming thus is a major cause of climate change.

The problem of methane generation from livestock farming is not limited to ruminants, such as cattle. For example, it has been reported that pigs produce about 0.03 gigatonnes of enteric methane per year which, although much less than that produced by ruminants, are not negligible.

Reducing the greenhouse gas impact of livestock farming, such as dairy farming, is desirable.

According to the invention, there is provided a method of reducing the greenhouse gas impact of livestock farming, the method including
feeding a fuel gas comprising one or more hydrocarbons, or a fuel gas comprising at least CO and H₂, to an anode of a solid oxide fuel cell stack;
withdrawing air, that includes methane originating from livestock, from a livestock housing or enclosure and feeding the withdrawn air to a cathode of the solid oxide fuel cell stack;
allowing oxygen in the air exothermically to react with the one or more hydrocarbons in the fuel gas, with the CO and H₂ fed as part of the fuel gas, or with CO and H₂ generated by reforming of the one or more hydrocarbons in the fuel gas to form at the anode a heated first exhaust stream comprising water and carbon dioxide, and at the cathode a heated second exhaust stream comprising methane, thereby generating an electrical current from the solid oxide fuel cell stack through an external electrical circuit; and
feeding at least the heated second exhaust stream to a combustor and combusting the heated second exhaust stream in the combustor, producing a heated tail gas stream.

The present invention will now be further described. In the following passages different aspects of the invention are defined in more detail. Each aspect so defined may be combined with any other aspect unless clearly indicated to the contrary, or unless clearly not technically feasible. In particular, any feature indicated as preferred or advantageous may be combined with any other feature or features indicated as being preferred or advantageous.

In this specification, the term “solid oxide fuel cell stack” is intended to include any solid oxide fuel cell system comprising a plurality of solid oxide fuel cells for the electrochemical oxidation of hydrogen, carbon monoxide or other organic intermediates, such as light hydrocarbons, by oxygen ions, whether the fuel cells are in fact stacked or associated in a different arrangement.

As would be known to those skilled in the art, a solid oxide fuel cell has an electrolyte that is a solid, non-porous metal oxide, e.g. Y₂O₃-stabilized ZrO₂ or scandia stabilised zirconia or gadolinium doped ceria. The solid oxide fuel cell typically operates at a temperature of 600-1000° C. where ionic conduction by oxygen ions takes place. The anode may for example be a Ni-ZrO₂ cermet and the cathode may for example be Sr-doped LaMnO₃. The solid oxide fuel cell is constructed with two porous electrodes, i.e. the anode and the cathode, that sandwich the solid electrolyte. Air flows along the cathode. When an oxygen molecule contacts a cathode/electrolyte interface, it acquires electrons from the cathode. The oxygen ions diffuse into the electrolyte material and migrate or diffuse to the other side of the solid oxide fuel cell where they contact the anode. The oxygen ions encounter the fuel at an anode/electrolyte interface and react catalytically with hydrocarbons, CO and/or H₂, giving off water, carbon dioxide, heat, and electrons. The electrons transport from the anode back to the cathode through an external electrical circuit, providing electrical energy. Typically, solid oxide fuel cells are of planar or tubular geometry, typically only a few millimetres thick, and are stacked together or connected in series by electrically conductive interconnects to form what is often referred to as a solid oxide fuel cell stack.

Solid oxide fuel cells allow conversion of a wide range of fuels, including various hydrocarbon fuels such as methane, propane, butane, diesel and biofuels, with heavier hydrocarbons such as diesel requiring upstream reforming. The relatively high operating temperature allows for highly efficient conversion to power, internal reforming of lighter hydrocarbons such as methane, and high-quality by-product heat for cogeneration or for use in a bottoming cycle. Indeed, it has been reported that both simple-cycle and hybrid solid oxide fuel cell systems have demonstrated among the highest efficiencies of any power generation system, combined with minimal air pollutant emissions and low greenhouse gas emissions. These capabilities have made solid oxide fuel cells an attractive emerging technology for stationary power generation in the 2 kW to 100 s MW capacity range. More recently, (planar) solid oxide fuel cell systems with high power densities operating at lower temperatures (700 to 850° C. instead of 900 to 1000° C. as was previously the norm) have been developed. This may help reduce the cost of the solid oxide fuel cell because less-expensive materials of construction can possibly be used at lower operating temperatures.

Typically, both the heated second exhaust stream, which is depleted in oxygen, and the heated first exhaust stream, which is enriched with water vapour and carbon monoxide, are fed to the combustor and combusted in the combustor. Thus, the heated second exhaust stream and the heated first exhaust stream may be combined before being fed to the combustor.

The heated first exhaust stream may be at a temperature of at least about 600° C., preferably a temperature of at least about 650° C., e.g. about 700° C.

Typically, the heated first exhaust stream is at a temperature which does not exceed 1000° C.

The heated second exhaust stream may be at a temperature of at least about 600° C., preferably a temperature of at least about 650° C., e.g. about 700° C.

Typically, the heated second exhaust stream is at a temperature which does not exceed 1000° C.

Advantageously, a combustor typically used to combust hydrocarbons from any hydrocarbon slip from the anode of the solid oxide fuel cell stack, i.e. hydrocarbons still present in the heated first exhaust stream, can thus be used also to combust the methane from the livestock housing or enclosure. The method of the invention may thus employ biogas in a combined heat and power plant (CHP plant) making use of a solid oxide fuel cell stack. This negates the need for separate methane capture and combustion technology to reduce the greenhouse gas impact of livestock farming where a livestock housing or enclosure is used, and a source of fuel gas comprising one or more hydrocarbons is available. As will be appreciated, the methane from the livestock housing or enclosure is converted to carbon dioxide in the combustor, thus drastically reducing the effect of the methane produced by the livestock on warming the atmosphere.

Preferably, the combustor is a catalytic combustor.

The catalyst of the catalytic combustor may be a Pd on an oxide support or Pd and Pt on an oxide support catalyst, e.g. a PdPt/alumina catalyst. Other suitable catalysts may be Pd or Pt on other solid oxide supports such as CeO₂, ZrO₂, SiO₂, MgO, and mixtures thereof. Base metals (e.g. Ni, Fe, Cu) supported on alumina or coprecipitated with alumina can also be used for operation/combustion at more than 800° C. but typically require high metal loadings of >10% by weight base metal.

The combustor may operate at a combustion temperature in the range of about 300° C. to about 900° C., preferably in the range of about 500° C. to about 900° C., more preferably in the range of about 600° C. to about 800° C., e.g. about 650° C.

The fuel gas may be biogas produced from agricultural waste. In one embodiment of the invention, the fuel gas is biogas obtained from agricultural waste slurry through anaerobic digestion, e.g. in covered slurry tanks or digesters.

The agricultural waste may include manure, or may be obtained essentially from manure. It is believed that biogas obtained from manure would comprise about 50% carbon dioxide and about 50% methane by volume, with minimal amounts of nitrogenic and/or sulphureous gases, and hydrogen. Some variation in composition can be caused by nutrients available in the soil, livestock feed, and manure collection systems, amongst other factors.

The heated tail gas stream may be used in indirect heat exchange relationship with the withdrawn air to heat the withdrawn air prior to feeding the withdrawn air to the solid oxide fuel cell stack.

The withdrawn air, prior to feeding the withdrawn air to the solid oxide fuel cell stack, may be heated to a temperature of at least about 600° C., e.g. about 700° C.

A portion of the heated withdrawn air may bypass the solid oxide fuel cell stack and may be fed to the combustor. This may be necessary, for example, where the rate of withdrawal of air from the livestock housing or enclosure exceeds the rate at which air can be fed to the cathode of the solid oxide fuel cell stack whilst maintaining the solid oxide fuel cell stack at its design operating temperature and considering the mass flow rate of fuel gas available. As will however be appreciated, this may lead to lower temperatures in the combustor and potentially a combustion process which is less efficient at converting methane and carbon monoxide to carbon dioxide. To address this potential issue, the withdrawn air bypassing the solid oxide fuel cell stack may be heated prior to being fed to the combustor, e.g. in a heat exchanger using a heat transfer material or other source of heat.

The withdrawn air may be compressed prior to feeding the withdrawn air to the cathode of the solid oxide fuel cell stack. The heated tail gas stream may be used to provide energy for the compression of the withdrawn air. Thus, in one embodiment of the invention, the heated tail gas is passed through a tail gas expander driving a compressor for purposes of compressing the withdrawn air. As will be appreciated, in this embodiment of the invention, the fuel gas will typically also be provided at pressure, or is compressed in the method of the invention.

When compression is employed for the withdrawn air, the fuel gas is typically fed to the solid oxide fuel cell stack at about the same pressure as the compressed air.

The withdrawn air may have a methane concentration of at least about 10 ppm, preferably at least about 50 ppm, more preferably at least about 100 ppm, e.g. about 200 ppm.

Typically, the withdrawn air has a methane concentration which does not exceed about 250 ppm or about 300 ppm.

Typically, the methane is methane generated by enteric fermentation during digestion in ruminants, such as cattle, sheep, goats or elk.

Heat from the heated tail gas may be used to heat the livestock housing or enclosure. Heating the livestock housing or enclosure may be advantageous when the livestock housing or enclosure is in a cold climatic region.

Instead, heat from the heated tail gas may be used to cool the livestock housing or enclosure using a heat to cooling technology. Cooling the livestock housing or enclosure may be advantageous when the livestock housing or enclosure is in a hot climatic region.

The solid oxide fuel cell stack generates an electrical current through an external electrical circuit, as hereinbefore stated. In other words, the solid oxide fuel cell stack generates electricity. The electricity may be used to cool the livestock housing or enclosure.

Instead, at least some of the electricity generated, if not substantially all of the electricity generated may be used in withdrawing air from the livestock housing or enclosure, i.e. to ventilate the livestock housing or enclosure. This will typically be the case where a tail gas expander-driven compressor is not used to withdraw and compress the air from the livestock housing or enclosure.

In another embodiment of the invention, at least some of the electricity generated may be fed into an electricity supply grid.

Heat from the heated tail gas may be used to heat water, e.g. for sterilization purposes in dairy farming.

In one embodiment of the invention, heat from the heated tail gas is used to evaporate water, i.e. to generate water vapour or steam.

At least a portion of the heated water, in the form of water vapour, may be added to the fuel gas prior to the fuel gas being fed to the anode of the solid oxide fuel cell stack. Water vapour (steam) is typically required to reform methane and light hydrocarbons in the biogas to form hydrogen and carbon monoxide (i.e. synthesis gas) by way of steam reforming (also known as steam methane reforming), so that the hydrogen and carbon monoxide can be used at the anode of the solid oxide fuel cell stack to react with oxygen ions that diffused from the cathode through the solid oxide electrolyte of the solid oxide fuel cells, to generate an electrical current from the solid oxide fuel cell stack through the external electrical circuit.

If insufficient heat is available from the heated tail gas to heat water for purposes of steam generation, another heat source, e.g. biogas as a heating fuel for combustion, may be used to generate steam.

The reforming may be a separate unit operation effected on the fuel gas, prior to the fuel gas being fed to the anode. Instead, or in addition, the reforming may take place at the anode of the solid oxide fuel cell stack, i.e. direct internal reforming using for example a Ni-based catalyst. As will be appreciated, in the latter instance, the anode must be configured also to act as a catalyst for steam methane reforming and the internal reforming, being an endothermic process, advantageously assists in cooling the solid oxide fuel cell stack.

In one embodiment of the invention, when both reforming as a separate unit operation and direct internal reforming are used, the reforming as a separate unit operation is in the form of a partial reforming unit operation.

The water heated by the heated tail gas may be water condensed from the tail gas.

The method or process of the invention may include recirculating a portion of the heated first exhaust stream from the anode back to the anode, to provide steam to the anode for internal reforming purposes.

The method or process of the invention may include recirculating a portion of the heated first exhaust stream from the anode to a reformer upstream of the solid oxide fuel cell stack, to provide steam to the reformer for reforming or partial reforming of the fuel gas.

The external electrical circuit, i.e. the electricity generated by the solid oxide fuel cell stack, may be used in the production of milk. For example, the external electrical system may be used to cool milk, for vacuum pumps, for ventilation or for lighting.

The livestock housing or enclosure may be a barn or housing or enclosure for dairy cows.

In one embodiment of the invention, the livestock housing or enclosure is a milking parlour or milking parlor or milking shed. In another embodiment of the invention, the livestock housing is a barn for dairy cows, preferably a barn for dairy cows located in close proximity to a milking parlour or milking parlor or milking shed.

As will be appreciated, the livestock may thus be dairy cows.

The withdrawn air may be desulphurized prior to feeding the withdrawn air to the cathode of the solid oxide fuel cell stack. H₂S is corrosive and is a poison for the typical materials used as cathode material (and the typical materials used as anode material) in a solid oxide fuel cell stack. Any suitable desulphurization technology can be employed, such as direct contact with water (water scrubbing) or with a suitable organic solvent, such as the dimethyl ether of polyethylene glycol (e.g. on packed beds or in spray towers), chemical absorption (e.g. using NaOH or Fe³⁺/EDTA), adsorption, whether physisorption or chemisorption (typically suitable at pressures exceeding 2 bar) using e.g. activated carbon, impregnated (NaOH or KOH) activated carbon, zeolites, or an iron oxide-based material, or biotechnological desulphurization.

The method or process of the invention may employ the use of a chromium getter to remove chromium species from the withdrawn air fed to the cathode of the solid oxide fuel cell stack. Gas phase chromium species poisoning is one of the major causes of cathode degradation in solid oxide fuel cells. The inventors however do not expect the use of a chromium getter to be necessary, unless a portion of the heated second exhaust stream comprising methane is recycled to the cathode, potentially leading to a build-up of gas phase chromium species in the air being fed to the cathode of the solid oxide fuel cell stack.

Typically, the withdrawn air is filtered to remove particulate material, prior to the withdrawn air being fed to the cathode of the solid oxide fuel cell stack.

In the method or process of the invention, the anode of the solid oxide fuel cell stack may be a Ni—ZrO₂ cermet.

In the method or process of the invention, the cathode of the solid oxide fuel cell stack may be a Sr-doped LaMnO₃.

In the method or process of the invention, the solid electrolyte of the solid oxide fuel cell stack may be a Y₂O₃-stabilized ZrO₂.

The invention will now be described, by way of example with reference to the following non-limiting drawings, in which

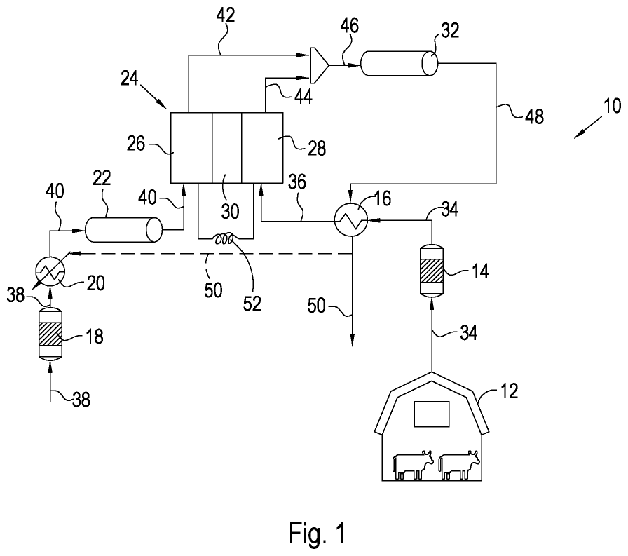

FIG. 1 shows a schematic of one embodiment of a method or process in accordance with the invention for reducing the greenhouse gas impact of livestock farming; and

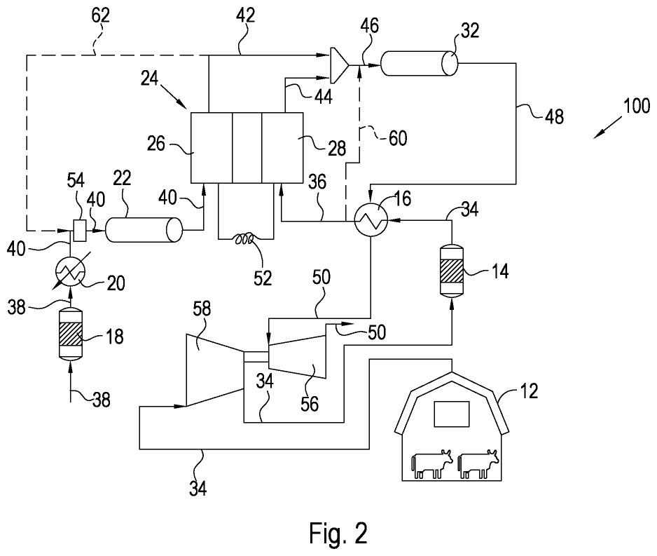

FIG. 2 shows a schematic of a more complicated embodiment of the method or process in accordance with the invention for reducing the greenhouse gas impact of livestock farming.

Referring to FIG. 1 of the drawings, reference numeral 10 generally indicates a method or process in accordance with the invention for reducing the greenhouse gas impact of livestock farming. The method 10 broadly employs a dairy barn 12, a purifier 14 for air withdrawn from the dairy barn 12, a first heat exchanger 16, a purifier 18 for biogas, a second heat exchanger 20, a biogas fuel processor 22, a solid oxide fuel cell stack 24 comprising an anode 26, a cathode 28 and a solid oxide electrolyte 30 sandwiched between the anode 26 and the cathode 28, and a tail gas combustor 32.

A withdrawn air line 34 leads from the dairy barn 12 to the purifier 14, and from the purifier 14 to the first heat exchanger 16. A heated withdrawn air line 36 leads from the first heat exchanger 16 to the cathode 28 of the solid oxide fuel cell stack 24.

A biogas feed line 38 leads from a covered slurry tank or digester or a bulk biogas storage facility (not shown) to the purifier 18 and from the purifier 18 to the second heat exchanger 20. A heated biogas line 40 leads from the second heat exchanger 20 to the biogas fuel processor 22 and from the biogas fuel processor 22 to the anode 26 of the solid oxide fuel cell stack 24.

A heated first exhaust stream line 42 leads from the anode 26 of the solid oxide fuel cell stack 24 and is joined by a heated second exhaust stream line 44 leading from the cathodes 28 of the solid oxide fuel cell stack 24. A combined exhaust stream line 46 leads to the tail gas combustor 32. A heated tail gas stream line 48 leads from the tail gas combustor 32 to the first heat exchanger 16, with a tail gas vent line 50 leading from the first heat exchanger 16 to atmosphere.

As shown by a broken line in FIG. 1 of the drawings, the tail gas vent line 50 may optionally run to the second heat exchanger 20 prior to venting to atmosphere.

An external electrical circuit powered by the solid oxide fuel cell stack 24 is indicated by reference numeral 52.

The method or process 10, as illustrated, is proposed to mitigate the greenhouse gas impact of a dairy farm, but is equally suitable for use with livestock ruminants other than cattle.

In accordance with the method or process 10, air from the dairy barn 12 is thus withdrawn by means of the withdrawn air line 34, e.g. using a blower (not shown) and fed to the purifier 14. Potentially, the blower can form part of the external electrical circuit 52 and hence may be powered by the solid oxide fuel cell stack 24.

For a typical dairy barn 12 used in a commercial dairy farming operation, the air is withdrawn at a rate sufficient to maintain the methane concentration in the air at less than about 200 ppm. As will be appreciated, the methane is generated by enteric fermentation in dairy cows within the dairy barn 12. The withdrawn air is fed by means of the withdrawn air line 34 to the purifier 14, where the air is desulphurised and filtered and, if required, treated or contacted with a chromium getter to remove gas phase chromium species from the air. The operation of a purifier such as the purifier 14 is well-known to those skilled in the art and is not described in any detail. Suffice to mention that any suitable desulphurisation technology can be employed, such as water scrubbing.

Purified or cleaned withdrawn air is fed from the purifier 14 to the first heat exchanger 16 by means of the withdrawn air line 34 and in the first heat exchanger 16 the air is heated, e.g. to a temperature of about 600°, by means of indirect heat exchange with heated tail gas from the heated tail gas stream line 48. From the first heat exchanger 16, the heated withdrawn air is fed by means of the heated withdrawn air line 36 to the cathode 28 of the solid oxide fuel cell stack 24.

Biogas produced from agricultural waste, predominantly manure produced by the dairy cows, is fed from covered slurry tanks or digesters or bulk storage (not shown) by means of the biogas feed line 38 to the purifier 18. The generation of biogas from agricultural waste, such as manure, is a well-known technology, can easily be implemented by those skilled in the art, and does not require further explanation.

In the purifier 18, the biogas is desulphurised and siloxanes are removed in conventional fashion, and the biogas is filtered if required. Purified biogas is then transferred by means of the biogas feed line 38 to the second heat exchanger 20.

In the second heat exchanger 20, the purified biogas is heated to a temperature of about 500° C.-700°C. and then transferred by means of the heated biogas line 40 to the biogas fuel processor 22.

The second heat exchanger 20 may be heated, at least to some extent, by means of the tail gas in the tail gas vent line 50, as shown by the broken line 50 in FIG. 1 of the drawings. Instead, or if insufficient heat is available from the tail gas in the tail gas vent line 50, additional alternative heating may be used, e.g. heat obtained from burning some of the biogas, or heat from an electrical heater, or an electrically heated catalyst unit may be employed, where a portion of the unit, typically an inlet portion, would be heated.

In the fuel processor 22, the heated biogas from the heated biogas line 40 is subjected to any required processing prior to being fed to the anode 26 of the solid oxide fuel cell stack 24 by means of the heated biogas line 40. Typically, the processing of the heated biogas in the biogas fuel processor 22 is conventional and includes reforming or partial reforming of the biogas to convert methane and other light hydrocarbons present in the biogas into hydrogen and carbon monoxide, i.e. synthesis gas. Reforming is a well-known technology known to those skilled in the art and is thus not described in any detail. Suffice to say that the reforming effected in the biogas fuel processor 22, whether partial or complete, is typically steam methane reforming employing a nickel-based catalyst or precious metal-based catalyst such as Rh on an oxide support (alumina, ceria, zirconia, etc. or a mixture thereof). For purposes of steam methane reforming, water vapour (not shown) obtained from first condensing water from the tail gas in the tail gas vent line 50 and then reevaporating the condensed water (e.g. by means of the burning of some of the biogas to provide the necessary heat), may be employed.

In the solid oxide fuel cell stack 24, oxygen ions from the heated withdrawn air being fed to the cathode 28 diffuse from the cathode 28 through the solid oxide electrolyte 30 to the anode 26, where the oxygen ions react exothermically with the hydrogen and carbon monoxide present at the anode to form water and carbon dioxide. The solid oxide fuel cell stack 24 operates at a temperature of about 600° C. to about 1000° C., employing for example a Ni—ZrO₂ cermet anode and a Sr-doped LaMnO₃ cathode, sandwiching between them a Y₂O₃-stabilised ZrO₂ solid, non-porous metal oxide electrolyte. Electrons are released from the anode and are transported through the external electrical circuit 52 to the cathode 28, thereby providing electrical energy.

A heated first exhaust stream, enriched in carbon monoxide and water vapour, is withdrawn from the anode 26 by means of the heated first exhaust stream line 42 and combined with a heated second exhaust stream withdrawn from the cathode 28 by means of the heated second exhaust stream line 44, before being fed by means of the combined exhaust stream line 46 to the tail gas combustor 32. As will be appreciated, the heated second exhaust stream withdrawn from the cathode 28 has a reduced oxygen concentration, compared to the air withdrawn from the dairy barn 12. The heated first exhaust stream and the heated second exhaust stream are essentially at the same temperature as the solid oxide fuel cell stack 24 when withdrawn from the solid oxide fuel cell stack 24, e.g. at a temperature of about 700° C. As will be appreciated, the combined exhaust stream 46 comprises the methane withdrawn from the dairy barn 12, as the methane simply passes over the cathode 28 of the solid oxide fuel cell stack 24 without reacting. In addition, the combined exhaust stream in the combined exhaust stream line 46 includes water (steam), carbon dioxide, unreacted hydrogen and unreacted carbon monoxide, and any hydrocarbons that slipped through the biogas fuel processor 22 and the anode 26 without being reformed.

In the tail gas combustor 32, the hydrogen, carbon monoxide, methane and other light hydrocarbons are combusted at a temperature of about 500° C. to about 800° C., preferably using a PdPt/alumina catalyst.

The tail gas combustor 32 thus produces a heated tail gas stream which is withdrawn by means of the heated tail gas stream line 48 and fed to the first heat exchanger 16 where it is used to heat the withdrawn air in the withdrawn air line 34 in indirect heat exchange relationship, before being vented to atmosphere by means of the tail gas vent line 50. As mentioned hereinbefore, the tail gas may optionally also be used to heat the biogas in the second heat exchanger 20, at least to some extent, if sufficient heat is available in the heated tail gas for doing so.

With reference to FIG. 2 of the drawings, a more complicated embodiment of the method or process of the invention to mitigate the greenhouse gas impact of livestock farming, is shown by reference numeral 100. In the method or process 100, the same reference numerals are used to indicate the same features as are used in FIG. 1 of the drawings, unless otherwise indicated.

As will be noted, the method or process 100 additionally includes a prereformer 54, a tail gas expander 56 and an air compressor 58.

A withdrawn air bypass line 60 is shown as a broken line leading from the heated withdrawn air line 36 to the combined exhaust stream line 46. Additionally, a heated first exhaust stream recycle line 62 is shown as a broken line branching off from the heated first exhaust stream line 42 and leading to the prereformer 54.

The method or process 100 is performed similarly to the method or process 10, as illustrated. In the event that the rate of withdrawal of air from the barn 12 exceeds the rate at which air can be fed to the cathode 28 of the solid oxide fuel cell stack 24, heated air can in the method or process 100 bypass the cathode 28 as illustrated by means of the heated withdrawn air bypass line 60 and be fed to the tail gas combustor 32, where the methane in the heated air is combusted.

In the method or process 100, a portion of the heated first exhaust stream in the heated first exhaust stream line 42 is optionally withdrawn by means of the heated first exhaust stream recycle line 62 and is fed to the prereformer 54. In this way, steam generated at the anode of the solid oxide fuel cell stack 24 can be fed to the prereformer 52 for purposes of prereforming the heated biogas from the heated biogas line 40.

In the method 100, the solid oxide fuel cell stack 24 operates at elevated pressure. As will be noted, the air compressor 58 is thus used to compress the air withdrawn from the dairy barn 12 by means of the withdrawn air line 34, to a pressure higher than atmospheric pressure. The air compressor 58 is driven by the tail gas expander 56 which receives tail gas at elevated pressure, from the tail gas vent line 50 leading from the first heat exchanger 16, before expanded tail gas is vented to atmosphere from the tail gas vent line 50 leading from the tail gas expander 56.

The method or process 10, 100, as illustrated, advantageously converts enteric fermentation methane in air withdrawn from a livestock housing or enclosure to water and carbon dioxide, thereby significantly reducing the greenhouse gas impact of the air in the livestock housing or enclosure. In the method or process 10, 100, the withdrawn air is elegantly heated in a solid oxide fuel cell stack provided with biogas and operating at an elevated temperature to facilitate combustion of the withdrawn air in a combustor associated with the fuel cell stack, obviating the need for a separate combustor for purposes of combusting the methane.

1. A method of reducing the greenhouse gas impact of livestock farming, the method including
feeding a fuel gas comprising one or more hydrocarbons to an anode of a solid oxide fuel cell stack;
withdrawing air, that includes methane originating from livestock, from a livestock housing or enclosure and feeding the withdrawn air to a cathode of the solid oxide fuel cell stack;
allowing oxygen in the air exothermically to react with the one or more hydrocarbons in the fuel gas to form at the anode a heated first exhaust stream comprising water and carbon dioxide, and at the cathode a heated second exhaust stream comprising methane, thereby generating an electrical current from the solid oxide fuel cell stack through an external electrical circuit; and
feeding at least the heated second exhaust stream to a combustor and combusting the heated second exhaust stream in the combustor, producing a heated tail gas stream.

2. The method according to claim 1, further comprising reforming of the one or more hydrocarbons in the fuel gas to CO and H₂, thereby allowing the oxygen in the air to exothermically react with the CO and H₂.

3. The method according to claim 1, wherein both the heated second exhaust stream and the heated first exhaust stream are fed to the combustor and combusted in the combustor.

4. The method according to claim 1, wherein the fuel gas is biogas produced from agricultural waste.

5. The method according to claim 1, wherein the heated tail gas stream is used in indirect heat exchange relationship with the withdrawn air to heat the withdrawn air prior to feeding the withdrawn air to the solid oxide fuel cell stack.

6. The method according to claim 5, wherein a portion of the heated withdrawn air bypasses the solid oxide fuel cell stack and is fed to the combustor.

7. The method according to claim 1, wherein the withdrawn air is compressed prior to feeding the withdrawn air to the cathode of the solid oxide fuel cell stack, and wherein the heated tail gas stream is used to provide energy for the compression of the withdrawn air.

8. The method according to claim 1, wherein heat from the heated tail gas is used to heat the livestock housing or enclosure, or to cool the livestock housing or enclosure using a heat to cooling technology.

9. The method according to claim 1, wherein the external electrical circuit is used to cool the livestock housing or enclosure.

10. The method according to claim 1, wherein heat from the heated tail gas is used to evaporate water, with at least a portion of the water vapour being added to the fuel gas prior to the fuel gas being fed to the anode of the solid oxide fuel cell stack.

11. The method according to claim 10, wherein the water heated by the heated tail gas is water condensed from the tail gas.

12. The method according to claim 1, wherein the external electrical circuit is used in the production of milk.

13. The method according to claim 1, wherein the livestock housing or enclosure is a barn for dairy cows, and wherein the livestock are dairy cows.

14. The method according to claim 1, wherein the external electrical circuit is used to withdraw said air that includes methane from the livestock housing or enclosure.
